(19) United States
(12) Patent Application Publication
(10) Pub. No.: US 2017/0166033 A1
(43) Pub. Date: Jun. 15, 2017

(54) ARRANGEMENT AND METHOD FOR FEEDING VENTILATION AIR TO A VENTILATION DEVICE FOR A VEHICLE INTERIOR, AND MOTOR VEHICLE

(71) Applicant: FORD GLOBAL TECHNOLOGIES, LLC, Dearborn, MI (US)

(72) Inventor: Alejandro Cristian Vagni, Köln (DE)

(21) Appl. No.: 15/359,185

(22) Filed: Nov. 22, 2016

(30) Foreign Application Priority Data
Dec. 9, 2015 (DE) 102015224687.6

(51) Int. Cl. B60H 1/26; B60H 1/28

(52) U.S. Cl. CPC B60H 1/26; B60H 1/28

(57) ABSTRACT

An arrangement is provided for feeding ventilation air to a ventilation device. The arrangement includes an air chamber and an air guide dividing the air chamber into a first subchamber and a second subchamber. A countercurrent air stream formed in the second subchamber is fed by the air guide into the first subchamber so that the countercurrent air stream impinges in a direction substantially opposite to a main air stream formed in the first subchamber.

### TECHNICAL FIELD

The invention relates to an arrangement and to a method for feeding ventilation air to a ventilation device for a vehicle interior and relates to a motor vehicle having a corresponding arrangement.

### BACKGROUND

Motor vehicles often have a closed vehicle interior, which is typically designed as a passenger compartment to accommodate passengers of the motor vehicle or, alternatively, as a load space separated from said compartment or connected thereto. In this case, the vehicle interior can be supplied with fresh air by means of a ventilation device. A heating and/or air-conditioning device is/are generally connected to the ventilation device, which usually comprises a ventilation fan for actively supplying air, and can form a unit with said device, which is also referred to as a heating, ventilation and air-conditioning unit (HVAC).

The ventilation air to be fed to the vehicle interior is usually received through an air inlet opening arranged in front of the windshield of the motor vehicle and extending in the transverse direction of the motor vehicle. From the air inlet opening, the ventilation air passes into an air chamber, within which it flows to an air outlet opening of the air chamber and, through the latter, enters the ventilation device. The ventilation device delivers the ventilation air to the vehicle interior in a temperature-controlled or air-conditioned form.

The air inlet opening can have an inlet grille in order to prevent the ingress of leaves or other relatively large objects. On the other hand, water in the form of droplets impinging as rain or spray can pass through the air inlet opening and, as a result, enters the air chamber. There is therefore a known practice of designing the arrangement for feeding in air, in particular the air chamber, in such a way that the water is removed and does not enter the ventilation device. It is furthermore desirable to make available the ventilation air to the ventilation device at a suitable, uniform pressure and with a mass flow that is adequate, even under different operating conditions, e.g. at different settings of the ventilation fan. The air chamber likewise serves to keep unwanted heat from the engine compartment away from the ventilation device and the vehicle interior.

Under unfavorable conditions, there is the possibility with known air feed arrangements that the air flow produced within the air chamber has a velocity that is sufficiently high to pick up separated water that may be present in the bottom region of the air chamber and to introduce it in the form of droplets into the ventilation device. At high driving speeds, e.g. above 140 km/h, and in the case of vehicles with a large pressure gradient between the air inlet opening and the air outlet opening, there may furthermore occasionally be an uncontrolled air flow through the ventilation device. One known way to avoid this is to take measures for dynamic pressure compensation, e.g. appropriate additional devices and/or appropriate control of the ventilation device, but this is associated with a high outlay.

US 2010/0052364 A1 discloses an air feed arrangement in a vehicle, said arrangement having an air inlet, an air outlet, an air flow path and a flow restricting device. The flow restricting device is arranged in the air flow path between the air inlet and the air outlet and is designed and arranged in such a way as to automatically reduce the air flow from the air inlet to the air outlet when the air flow through the air inlet increases.

According to US 2014/0017987 A1, an air feed arrangement comprises a housing having an air inlet and an air outlet as well as a cowl within the housing. The cowl is arranged in such a way that the air stream is split into two air stream portions, wherein a first air stream portion flows through between the cowl and an upper part of the housing and the second air stream portion flows through below the cowl. After passing the cowl, the first and second air stream portions enter the air outlet.

It is the object of this document to specify an arrangement and a method for feeding ventilation air to a ventilation device for a vehicle interior, and to specify a motor vehicle having a corresponding arrangement, wherein the abovementioned disadvantages are as far as possible avoided, wherein, in particular, an adequate and uniform air supply to the ventilation device is made possible and entrainment of liquid water can be avoided in a simple manner, even under different operating conditions.

This object is achieved by an arrangement and by a method and a motor vehicle as specified herein.

An arrangement according to the invention for feeding ventilation air to a ventilation device for a vehicle interior, which is also referred to below as an air feed arrangement, comprises an air chamber, which has a first air inlet opening and an air outlet opening. The air chamber can have further air inlet openings. The air outlet opening can simultaneously form or be connected to an intake opening of the ventilation device, through which the ventilation air to be fed to the vehicle interior enters the ventilation device. The ventilation device for the vehicle interior is preferably designed as a heating, ventilation and air-conditioning unit (HVAC). In particular, the vehicle interior is a passenger compartment and/or a load space of a motor vehicle. The air chamber is designed to form a main air stream from the first air inlet opening to the air outlet opening. At least some of the air to be fed to the ventilation device thus passes through the first air inlet opening and optionally further air inlet openings into the air chamber, flows from there along a flow path as a main air stream through the air chamber to the air outlet opening and passes through the latter to the ventilation device. During this process, the main air stream flows along a substantially helical flow path. The main air stream thus forms a helix or a cyclone in the air chamber, thereby allowing efficient water separation from the main air stream in a simple manner.

The air feed arrangement comprises an air guide, which divides the air chamber into a first subchamber and a second subchamber. The first subchamber has the first air inlet opening and the air outlet opening and is designed in such a way that the main air stream flows from the first air inlet opening to the air outlet opening within the first subchamber and, during the process, forms the cyclone. The second subchamber likewise has an air inlet opening, which is referred to here as a second air inlet opening; the second subchamber can have further air inlet openings. According to the invention, the air entering the second subchamber through the second air inlet opening and optionally further air inlet openings forms a countercurrent air stream. The air guide is furthermore designed to feed the countercurrent air stream out of the second into the first subchamber in such a way that the countercurrent air stream in the first subchamber impinges upon the main air stream in a direction substantially opposed to a flow direction of the main air stream. Thus, the air guide is arranged and configured in such a way that a countercurrent air stream is formed which is guided into the flow path of the main air stream in a position and direction such that the flow direction of the countercurrent air stream is substantially opposed to that of the main air stream in the region where the air flows meet. In particular, the air guide is designed to feed the countercurrent air stream into an outlet region of the first subchamber or into a section upstream of the air outlet opening, said section being short in relation to the flow path of the main air stream from the first air inlet opening to the air outlet opening, with the result that the countercurrent air stream preferably impinges upon the main air stream in the region of the outlet opening or shortly ahead of said opening. The main air stream and the countercurrent air stream are thus combined shortly ahead of the outlet opening and flow to the ventilation device together.

Providing an air guide for combining the main air stream from the first inlet opening to the outlet opening with an opposed countercurrent air stream makes it possible to ensure that the velocity of flow of the ventilation air flowing into the air outlet opening is reduced and, as a result, the risk that water on the bottom of the air chamber will be taken along and will enter the ventilation device is avoided. By this means, it is also possible in a simple manner to achieve a reduction in fluctuations of the pressure and mass flow and to supply ventilation air for the ventilation device at a suitable pressure and to largely compensate the dynamic pressure. At the same time, a particularly compact construction can be made possible by virtue of the fact that the air guide divides the air chamber into a first and a second subchamber, wherein the main air stream is formed in the first subchamber and the countercurrent air stream is formed in the second subchamber. In this arrangement, the first subchamber can have a progressive cross section in order to maximize compactness.

The air chamber is preferably of elongate design and, in particular, can be arranged transversely to a forward direction of the vehicle within which the vehicle interior is formed. Space-saving installation of the air chamber in the vehicle and configuration with an adequate volume can thereby be made possible. The second subchamber is furthermore preferably arranged in an end region of the elongate air chamber and the air outlet opening is arranged in an end region of the first subchamber adjoining the second subchamber. In the longitudinal or transverse direction of the air chamber, the second subchamber thus adjoins that end region of the first subchamber which has the air outlet opening. The air guide, which is arranged between the first and the second subchamber, therefore adjoins an outlet region of the first subchamber. A compact and simple configuration of the air feed arrangement and simple and effective feeding of the countercurrent air stream are thereby made possible.

It is furthermore preferred that, in relation to the installation position envisaged for the air feed arrangement within the vehicle, the air guide is designed as a vertical, horizontal or obliquely oriented dividing wall between the first and the second subchamber, which has a passage opening to guide the countercurrent air stream into the first subchamber. The dividing wall thus largely divides the first and the second subchamber from one another but allows a defined air flow in the form of a countercurrent air stream to pass from the second subchamber into the first subchamber. The passage opening can be of slot-shaped design, for example. Appropriate configuration of the passage opening makes it possible in a simple manner to configure the countercurrent air stream in such a way in terms of position, flow cross section and direction that it impinges upon the main air stream in a substantially opposed direction.

The dividing wall preferably extends at least into a region of the first subchamber situated opposite the air outlet opening or beyond said region. This is a simple way of enabling the countercurrent air stream to be fed into the flow path of the main air stream in the region of the outlet opening or of enabling a short section, in relation to the total flow path of the main air stream in the first subchamber, upstream of the outlet opening. At the same time, it is made possible for the countercurrent air stream not to be oriented directly at the outlet opening. This is a particularly effective way of making the air stream entering the ventilation device more uniform.

The air guide is preferably designed in such a way that the countercurrent air stream is fed in so as to be opposed to the main air stream at least in a tangential direction. If the countercurrent air stream did not impinge upon the main air stream, the countercurrent air stream would thus form in the first subchamber an eddy opposed to the main air stream. By virtue of the fact that the countercurrent air stream impinges upon the main air stream in a manner tangentially opposed thereto, compensation of the velocity component of the main air stream which is tangential to the helical flow path and hence a substantial reduction in the flow velocity and greater uniformity of the air stream into the air outlet opening, even at this stage, are possible.

It is furthermore preferred that the countercurrent air stream is also fed into the outlet region of the first subchamber in an axial direction in relation to the helix formed by the streamlines of the main air stream, in a direction opposed to the main air stream. Further improved calming and greater uniformity of the air stream is thereby made possible.

A water guide, by means of which the water separated out at the walls of the air chamber can be guided to one or more water drainage openings, is advantageously arranged within the air chamber. In particular, the water guide is designed as a substantially encircling flange or an encircling bead projecting inward from the walls of the air chamber. For example, the water guide can be arranged within the first subchamber between the passage opening and the outlet opening, i.e. downstream of the combination of the main air stream and the countercurrent air stream, and can thereby partition off an outlet region in the first subchamber. The water drainage device not only allows improved drainage of separated water and an additional safeguard against the ingress of water into the ventilation device but can furthermore contribute to greater uniformity of the air stream reaching the outlet opening and to minimization of pressure fluctuations.

The air guide itself is preferably designed for water separation, e.g. by the provision of an edge around which the countercurrent air stream flows. This is a simple way of ensuring that water droplets contained in the countercurrent air stream are separated out of the air stream. As an alternative or in addition, the air stream can likewise flow along a helical flow path within the second subchamber, wherein this flow path can be oriented so as to be opposed axially and tangentially to the flow of the main air stream. This additionally allows improved water separation in the second subchamber too.

According to a method for feeding ventilation air to a ventilation device for a vehicle interior, in an air chamber, which has an air outlet opening for feeding the ventilation air to the ventilation device and a first air inlet opening, a main air stream from the first air inlet opening to the air outlet opening is formed. The air chamber is divided into a first subchamber and a second subchamber, wherein the main air stream is formed in the first subchamber and flows along a substantially helical flow path from the first air inlet opening to the air outlet opening. A countercurrent air stream is furthermore formed in the second subchamber, and the countercurrent air stream is fed into the first subchamber in such a way that said stream impinges upon the main air stream in a direction substantially opposed to the flow direction of the main air stream. In particular, the countercurrent air stream is fed in so as to be opposed to the main air stream in a tangential direction and preferably also in an axial direction.

In accordance with an additional aspect, a motor vehicle is provided having an air feed arrangement designed as described above. In particular, the air chamber of the air feed arrangement extends transversely to a forward direction of the motor vehicle, wherein the first and the second air inlet opening are covered by a, preferably common, inlet grille. Together, the first and the second air inlet opening can form a continuous air inlet opening, which is arranged in the region of the cowl or directly in front of the windshield of the motor vehicle and extends substantially over the entire width thereof. The axis of the helix, which can be formed by the flow path of the main air stream, is preferably oriented in the transverse direction of the motor vehicle.

### BRIEF DESCRIPTION OF THE DRAWING FIGURES

The invention is explained in greater detail by way of example below with reference to the drawings, in which:

FIGS. 1a to 1d show, in schematic sections, a first illustrative embodiment of an arrangement for feeding ventilation air to a ventilation device for a vehicle interior;

FIGS. 2a and 2b show, in schematic sections, a second illustrative embodiment of an air feed arrangement;

FIG. 3 shows, in schematic form, a section through an air feed arrangement according to FIGS. 2a to 2c, wherein the air flow is shown in the case where there would be no main air stream;

FIGS. 4a and 4b show, in perspective, a third illustrative embodiment of an air feed arrangement, and

FIG. 5 shows, in perspective, a fourth illustrative embodiment of an air feed arrangement.

### DETAILED DESCRIPTION

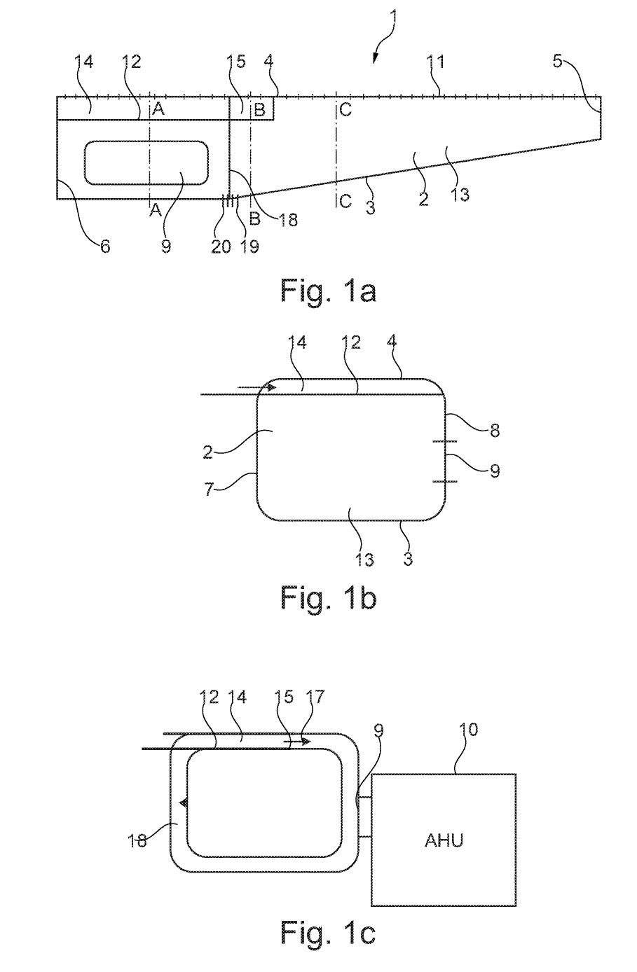

FIGS. 1a to 1d show an illustrative embodiment of an air feed arrangement 1 according to the invention in schematic form in various section planes. The section planes are denoted below with reference to the installation position of the air feed arrangement 1 in a motor vehicle; the terms “left” and “right” likewise refer to a forward direction of the motor vehicle. In the illustrative embodiments shown in the figures, the air feed device 1 is intended for a left-hand drive motor vehicle; here, the ventilation device is arranged on the right-hand side in front of the vehicle interior for reasons of space. In right-hand drive vehicles, the air feed device 1 can be designed in corresponding mirror-image fashion.

FIG. 1a shows a section in a vertical plane extending transversely to the forward direction of the motor vehicle. As shown in FIG. 1 a, the air feed arrangement 1 comprises an air chamber 2 of elongate design, which extends in the transverse direction of the motor vehicle and is delimited by a bottom 3, a top 4, side walls 5, 6 at the ends and a front wall 7 as well as a rear wall 8 (see also FIGS. 1b to 1d). The rear wall 8 has an air outlet opening 9, through which an air stream can flow to a ventilation device 10, which is indicated symbolically in FIG. 1c. Here, in the case of a left-hand drive vehicle, the air outlet opening 9 is situated on the right-hand side of the air chamber 2. In the illustrative embodiments described, the ventilation device 10 is a heating, ventilation and air-conditioning unit, which comprises at least one fan ventilator and devices for heating and air-conditioning the ventilation air flowing into the ventilation device 10 through the air outlet opening 9 and guided onward into a vehicle interior. In the region of the top 4, ahead of the air chamber 2 in the forward direction of the motor vehicle, there is an air inlet opening, which is closed by an inlet grille 11, which is likewise indicated symbolically in FIG. 1a.

Extending in a horizontal direction within the air chamber 2 is a horizontal dividing wall 12, which divides the air chamber 2 into a first and a second subchamber, which are here referred to as the first or main chamber 13 and the second or secondary chamber 14. As shown in the section shown in FIG. 1 b in a vertical plane parallel to the forward direction of the motor vehicle (denoted by A-A in FIG. 1a), the horizontal dividing wall 12 extends over the entire width of the air chamber 2 in the region of the air chamber 2 in which the air outlet opening 9 is arranged. In an adjoining region, which is shown in a corresponding section (B-B in FIG. 1a) in FIG. 1c, the dividing wall 12 forms a passage opening 15 to the main chamber 13. FIG. 1d illustrates a section through the air feed device 1 in a further parallel vertical longitudinal plane of the motor vehicle (C-C in FIG. 1a), seen from the left-hand side of the motor vehicle.

The air flow which forms within the air feed device 1 during the operation of the ventilation device 10, in particular during the operation of a ventilation fan of the ventilation device 10 while the motor vehicle is being driven, is indicated in FIGS. 1b to 1d. Through the inlet grille 11 and the air inlet opening, which is arranged in the upper region of the air chamber 2 and extends substantially over the entire width of the air chamber 2, air flows through respectively corresponding regions of the air inlet opening both into the main chamber 13 and into the secondary chamber 14. Under the influence of the dynamic pressure which arises while the motor vehicle is being driven and owing to the suction effect of the ventilation fan, a helix-shaped air flow which serves as a cyclone for water separation is formed in the main chamber 13. As illustrated in FIG. 1d, the tangential flow component of the main air stream 16 forming the cyclone is oriented counter to the forward direction of the motor vehicle in the region of the bottom 3, upward in the region of the rear wall 8, in the forward direction in the region of the top 4 and downward in the region of the front wall 7. The axial flow component of the main air stream 16 is directed to the right, i.e. in the direction of the air outlet opening 9. An air stream furthermore enters the secondary chamber 14 through that part of the air inlet opening in which the horizontal dividing wall 12 extends. Within the secondary chamber 14, this air stream is guided in the transverse direction of the motor vehicle to the passage opening 15, where it enters the main chamber 13 as a countercurrent air stream 17 and impinges upon the main air stream 16 axially and tangentially, counter to said stream. In the illustrative embodiment shown, the countercurrent air stream 17 enters the main chamber 13 in the region of the top 4 but has a velocity component counter to the forward direction of the motor vehicle and toward the right. Both the tangential and the axial flow velocity of the main air stream are thereby reduced or canceled out, with the result that the air flow has correspondingly lower flow velocities in the outlet region of the air chamber 2, i.e. in the region of the air outlet opening 9. It is thereby possible to achieve an air flow which is more uniform and can be controlled more effectively by means of the fan of the ventilation device 10 and to achieve a uniform static pressure in the main chamber 13 in the region of the air outlet opening 9.

In addition to functioning as an air guide, the horizontal dividing wall 12 can simultaneously function as a water guard. In the illustrative embodiment shown in FIGS. 1a to 1d, a flange 18 is arranged in the region of the passage opening 15 of the secondary chamber 14 in the air chamber 2, said flange running around in a vertical longitudinal plane of the motor vehicle, projecting inward from the walls of the air chamber 2 and serving as a water guide. The cyclone formed by the main air stream 16 leads to water droplets separating out of the main air stream 16 on the bottom 3, the top 4 and the front and rear walls 7, 8 of the air chamber 2. The separated water flows along the walls and along the bottom 3, which slopes in this region, to a water drainage opening 19 and can be discharged therefrom the air chamber 2. The encircling flange 18 prevents water from entering the region of the air outlet opening 9. The water droplets which enter the secondary chamber with the air entering said chamber are separated out on the walls of the secondary chamber 14 and are likewise retained by the flange 18 and guided to a further water drainage opening 20. The countercurrent air stream 17 guided through the passage opening 15 into the main chamber 13 is thus largely free from water droplets. Apart from the function of draining away water, the encircling flange 18 furthermore has the effect of making the air stream entering the region of the outlet opening 9 even more uniform.

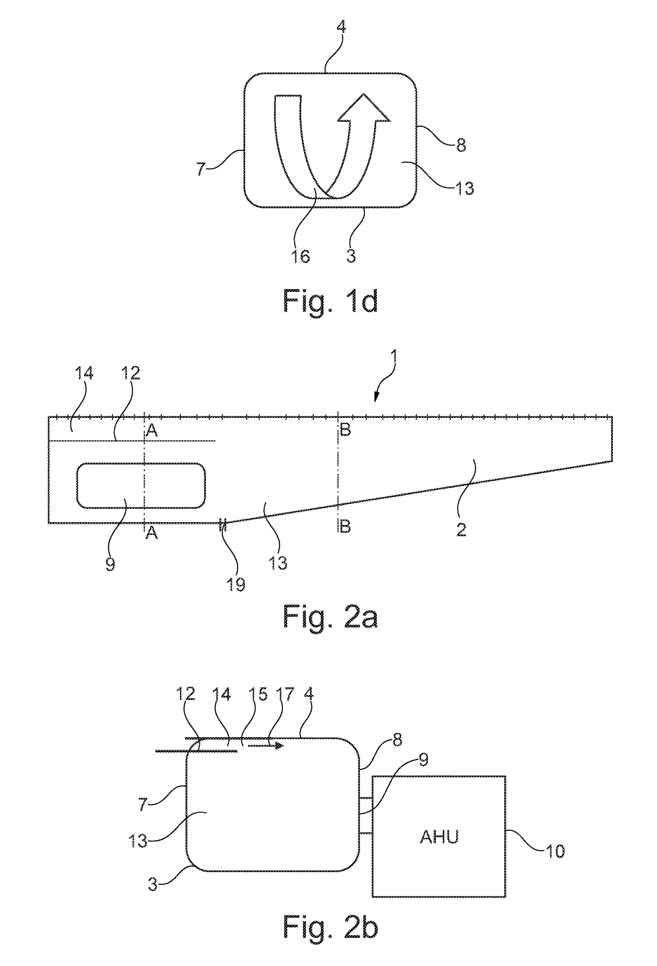

Another embodiment of the invention is shown in a corresponding manner in FIGS. 2a and 2b, wherein FIG. 2b shows a section in the plane A-A; a section in the plane B-B corresponds to FIG. 1d. In this case, the air inlet opening of the air chamber 2 is designed and arranged in such a way that water droplets can penetrate only to a slight extent, even in the rain, the air inlet opening being completely covered by the engine hood, for example. In this case, it may be sufficient for the horizontal dividing wall 12 to be made shorter in the forward direction of the motor vehicle, i.e. in the transverse direction of the air chamber 2. It is possible to dispense with any further water guard here. The passage opening 15 through which the countercurrent air stream 17 enters the main chamber 13 is arranged closer to the outlet opening 9 in the longitudinal direction of the air chamber 2. A single water drainage opening 19 is sufficient for any water which remains. In other respects, the illustrative embodiment shown in FIGS. 2a to 2c is of the same design as that described with reference to FIGS. 1a to 1d, and the tangential and axial components of the main air stream 16 are compensated in a corresponding manner by the countercurrent air stream 17.

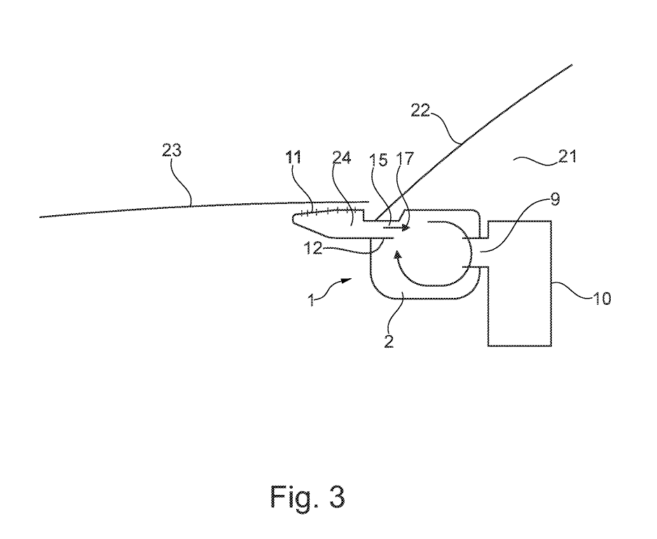

The installation of the air feed arrangement is shown schematically in FIG. 3 in a vertical longitudinal plane of the motor vehicle, as seen from the left-hand side of the motor vehicle. The air feed arrangement is installed in the front region of the vehicle cabin, i.e. in the region of the dashboard, underneath the windshield 22. The air inlet opening 24 of the air feed arrangement 1 is arranged in front of the windshield 22, being protected by the rear region of the engine hood 23. The air inlet opening 24 extends over the entire width of the windshield 22 and is covered by the inlet grille 11. If the main air stream were not present, the countercurrent air stream 17 guided into the main chamber 13 through the horizontal dividing wall 12 and the passage opening 15 would form an eddy therein with a tangential flow direction opposed to that of the main air stream 16 (see FIGS. 1d, 2c). As described above, combining the countercurrent air stream 17 with the main air stream 16 results in reduced eddy formation and thus more uniform and more effectively controllable flow in the region of the air outlet opening 9. The embodiment described with reference to FIGS. 2a to 2c is shown in FIG. 3. In the embodiment described in FIGS. 1a to 1d, the horizontal dividing wall 12 would be of correspondingly longer design in the longitudinal direction of the motor vehicle (see FIGS. 1b, 1c).

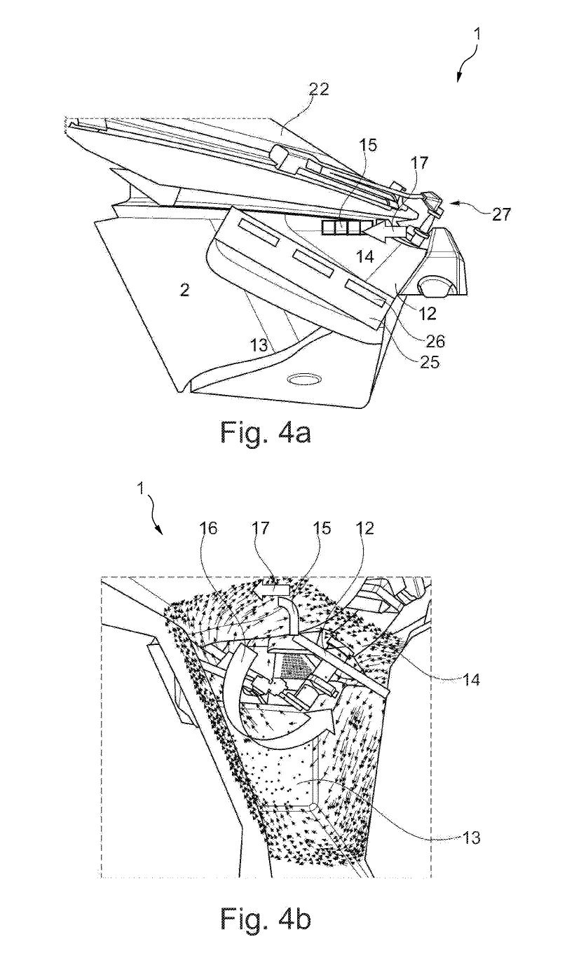

FIGS. 4a and 4b show an air feed arrangement 1 which corresponds essentially to the embodiment shown in FIGS. 1a to 1d. As FIG. 4a shows, the dividing wall 12 is arranged substantially horizontally in the air chamber 2 and extends over the right-hand part of the air chamber 2. Provided in the left-hand region of the horizontal dividing wall 12 is the passage opening 15, through which the countercurrent air stream 17 is guided into the main chamber 13. In order to avoid uncontrolled transfer of air from the secondary chamber 14 divided off by the dividing wall 12 into the main chamber 13, the secondary chamber 14 is closed off at the side by a side wall 25; the side wall 25 can have openings 26 to further reduce pressure fluctuations. A windshield wiper 27 is furthermore visible in FIG. 4a.

In FIG. 4b, the air flow prevailing in the main chamber 13, which forms the main air stream 16, is indicated by arrows. As is furthermore indicated in FIG. 4b, the countercurrent air stream 17 enters the main chamber 13 tangentially counter to the direction of the main air stream 16 through the passage opening 15 formed at the rear edge of the dividing wall 12. A reduction in flow velocity and a reduction of fluctuations in the pressure and the flow velocity in the outlet region of the main chamber 13 are thereby made possible.

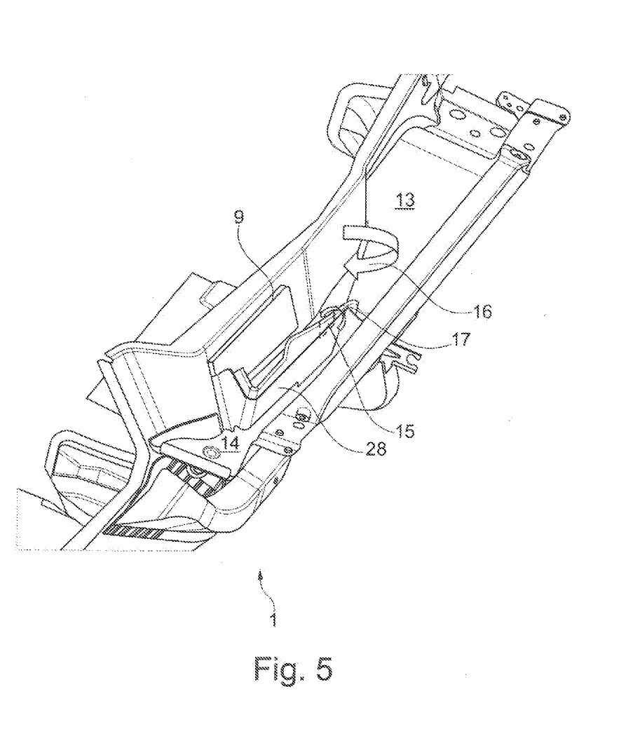

Another embodiment of the air feed arrangement 1 according to the invention is shown in a perspective view in FIG. 5. Here, the air chamber 2 is divided into a main chamber 13 and a secondary chamber 14 by an air guide, which is designed as a substantially vertically arranged dividing wall 28. The vertical dividing wall 28 is designed as a baffle plate with a double offset, which defines a region of the secondary chamber 14 which extends beyond the region of the air outlet opening 9. There, i.e. arranged within the air chamber 2 opposite the left-hand edge region of the air outlet opening 9, the vertical dividing wall 28 has a passage opening 15, through which a countercurrent air stream 17 can enter the main chamber 13 tangentially and axially counter to the flow direction of the main air stream 16. A cyclone for water separation can likewise be formed within the secondary chamber 14; the air guide or dividing wall 28 can furthermore have one or more edges around which the countercurrent air stream 17 is guided in order additionally to achieve a water separating effect.

For the sake of clarity, not all the reference signs are shown in all the figures. Reference signs that are not explained with reference to a figure have the same significance as in the other figures.

What is claimed:

1. An arrangement for feeding air to a ventilation device, comprising:
an air chamber;
an air guide dividing said air chamber into a first subchamber and a second subchamber;
a first air inlet opening and an air outlet opening in said first subchamber; and
a second air inlet opening in said second subchamber;
wherein said air guide feeds a countercurrent air stream formed in said second subchamber into said first subchamber so that said countercurrent air stream impinges in a direction substantially opposite to a flow direction of a main air stream formed in said first subchamber and moving from said first air inlet to said air outlet opening.

2. The arrangement as claimed in claim 1,
wherein the air chamber is of elongate design, the second subchamber is arranged in a first end region of the air chamber and the air outlet opening is arranged in a second end region of the first subchamber adjoining the second subchamber.

3. The arrangement as claimed in claim 2,
wherein the air guide is designed as a vertical, horizontal or obliquely oriented dividing wall that has a passage opening to guide the countercurrent air stream into the first subchamber.

4. The arrangement as claimed in claim 3,
wherein the dividing wall extends at least into a region of the first subchamber situated opposite the air outlet opening.

5. The arrangement as claimed in claim 4,
wherein the air guide for guiding the countercurrent air stream is oriented in a tangential direction counter to the main air stream.

6. The arrangement as claimed in claim 5,
wherein the air guide is designed so as to be oriented counter to the main air stream in a tangential direction and an axial direction.

7. The arrangement as claimed in claim 6,
wherein a water guide for guiding separated water to one or more water drainage openings is arranged within the air chamber.

8. The arrangement as claimed in claim 7,
wherein the air guide is designed to separate water from the countercurrent air stream.

9. A method for feeding ventilation air to a ventilation device, comprising:
dividing an air chamber into a first subchamber and a second subchamber;
forming a main air stream in said first subchamber flowing along a substantially helical flow path;
forming a countercurrent air stream in said second subchamber;
feeding said countercurrent air stream into said first subchamber so as to impinge upon said main air stream in a direction substantially opposed to said main air stream.
